(19) United States
(12) Patent Application Publication
(10) Pub. No.: US 2015/0364025 A1
(43) Pub. Date: Dec. 17, 2015

(54) WIRELESS INDOOR PERSONAL EVACUATIONS SYSTEM

(71) Applicant: Trojan Safety Services Ltd., Fort St. John (CA)

(72) Inventors: Allan Kirschner, Fort St. John (CA); Jeffrey Kirschner, Fort St. John (CA); Brendan McLennan, Fort St. John (CA)

(21) Appl. No.: 14/736,977

(22) Filed: Jun. 11, 2015

Related U.S. Application Data
(60) Provisional application No. 62/010,866, filed on Jun. 11, 2014.

(51) Int. Cl. G08B 21/12; G08B 5/36; G08B 3/10; G08B 25/10

(52) U.S. Cl. CPC G08B 21/12; G08B 25/10; G08B 5/36; G08B 3/10

(57) ABSTRACT

A personal evacuation alarm system is provided, including: a gas detection system; a control panel in communication with the gas detection system, the control panel including a wireless control board and a plurality of alarm ports, each alarm port connected to an outdoor audio alarm; a plurality of personal devices in wireless communication with the control panel, each of the personal devices including a plurality of light emitting diodes; and an audio emitter.

This application claims the benefit of U.S. Provisional Patent Application Ser. No. 62/010,866 filed Jun. 11, 2014, which is hereby incorporated by reference in its entirety.

### FIELD

This invention relates to alarm systems, and more particularly to personal gas detection alarm systems.

### BACKGROUND

Gas detection in industry has followed recent technology developments and has moved to wireless detection systems. Currently there are a number of alarm systems utilized in industry to detect gas (i.e. determine if a gas release has occurred) and to then indicate an alarm to personnel. These systems can be both wired and wireless with the majority of available systems still using wired technologies.

As work sites become larger indicator alarms, both audible and visual, become harder to register for personnel living on site due to a number of factors, including insulated trailers; other noise such as television; radio communication issues; visual or hearing impairment; and personnel sleeping. Other factors that impair alarm recognition include the visibility of indicating lights; blowing snow/dust; sunlight; distance to on site offices and accommodations; and audibility of the alarm.

Current alarm system indicators include strobe lights/beacons; sirens; buzzer alarms; air horns; and alarm bars (i.e. sirens with strobe lights). The current alarm systems main goal is area alarm notification. Such systems are used in outdoor or plant settings. Due to size and design they do not provide an adequate means for an indoor personal evacuation alarm.

An example of an alarm system in the art is EchoView Host™ provided by Rae Systems Inc. It is a battery operated handheld wireless device. EchoView Host is used in conjunction with personal gas detection monitors to display real time gas readings and alarm status.

Currently there are no known universal systems to provide indoor individual evacuation notice to personnel living on site or near the job location.

### SUMMARY

The system according to the invention provides a universal indoor personal evacuation alarm for gas detection systems. The existing alarm facilitates the activation of the personal evacuation system.

The system according to the invention provides a personal evacuation system in each of the offices and accommodation trailers on a work site. The alarm will provide both a visual and audible notification to notify personnel. The visual alarm visually notifies the personnel of the area that a gas release was detected using a color coded series of flashing LED lights so an appropriate evacuation route can be selected. The system provides the end user with an evacuation system to ensure personnel have the ability to be notified immediately in the event of a potentially dangerous situation. The system may be used in the oil and gas industry during drilling and completion activities and has personnel safety as the primary objective.

A wireless personal evacuation device is provided, including: a wireless receiver for receiving signals related to a presence of gas and a location associated with the gas presence; a plurality of light emitting diodes; arranged in rows, the diodes in each row having a different color; an audio emitter; a control board for processing the signal; wherein on receipt of the signal, the control board actuates the diodes in the row corresponding to the location. The wireless personal evacuation device may be located in a different building from the location. The wireless personal evacuation device may include an audible alarm actuated on receipt of the signal. The diodes may further indicate the device is powered. The location may be associated with one of a plurality of zones and the diodes may be arranged in rows on the device, each row associated with one of the plurality of zones. Each row of diodes may be a different color.

A personal evacuation alarm system is provided, including: a gas detection system; a control panel in communication with the gas detection system, the control panel including a wireless control board and a plurality of alarm ports, each alarm port connected to an outdoor audio alarm; a plurality of personal devices in wireless communication with the control panel, each of the personal devices including a plurality of light emitting diodes; and an audio emitter. The control panel may be configured to receive a signal from the gas detection system indicating a presence of gas and a zone associated with the presence. The plurality of light emitting diodes may be arranged in rows, each row associated with a zone. The control panel may also be configured to send a wireless signal to each of the plurality of personal devices, the signal including the zone associated with the gas presence. Each of the personal devices may be configured to actuate the row of light emitting diodes associated with the zone indicated in the received signal. The personal devices may be positioned in buildings different from the gas detection system and the control panel may be further configured to actuate a plurality of outdoor audio alarms on receipt of the signal indicating the presence of gas.

A method of providing a personal evacuation signal, including: determining, by a gas detection system, a presence of gas and a zone associated with a location of the gas; communicating the presence of gas and the zone via a wired connection to a control panel; communicating the presence of gas and the zone via a wireless connection to a plurality of personal devices; and emitting a visible and auditory signal from each of the personal devices. The personal devices may be located in buildings different from the gas detection system and the visible signal may include the actuation of a plurality of light emitting diodes, the light emitting diodes positioned in a row associated with the zone.

### BRIEF DESCRIPTION OF THE DRAWINGS

FIGS. 1A and 1B are front and sides views of an embodiment of a wireless personal evacuation system according to the invention.

FIG. 2 is a block diagram showing the environment wherein an embodiment of the wireless personal evacuation system may operate.

FIG. 3 is a block diagram showing the system according to the invention

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Where two or more terms or phrases are synonymous (e.g., because of an explicit statement that the terms or phrases are synonymous), instances of one such term/phrase does not mean instances of another such term/phrase must have a different meaning For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b) or similar law in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

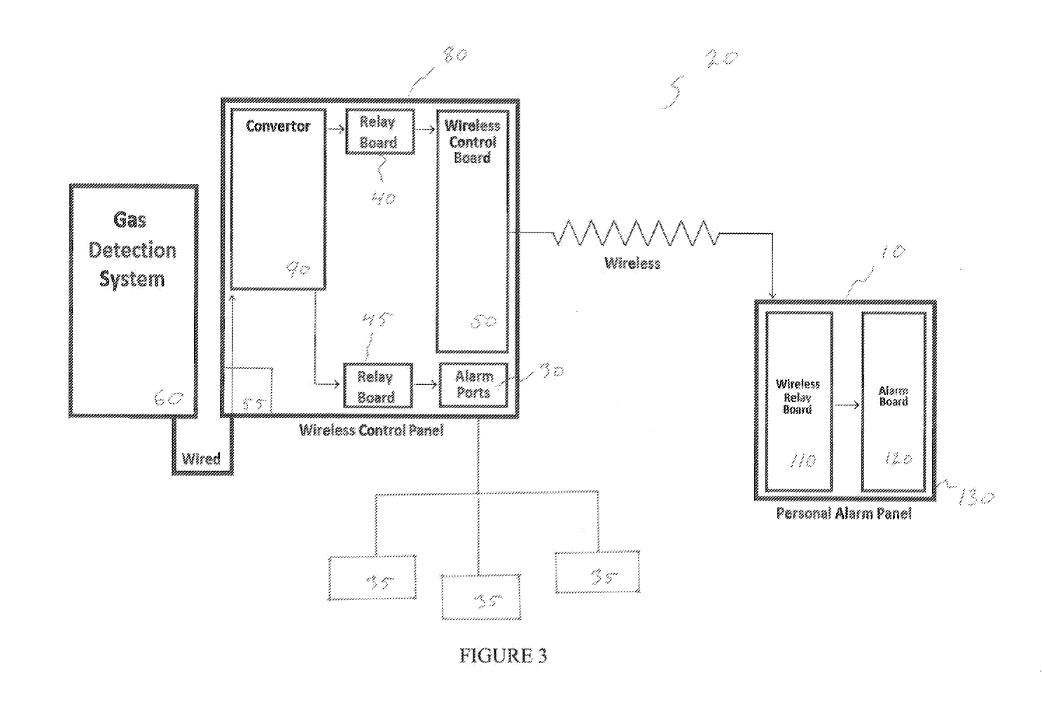

The system according to the invention, and as shown in FIG. 3, includes a universal personal evacuation alarm 10 for use with an alarm system 20.

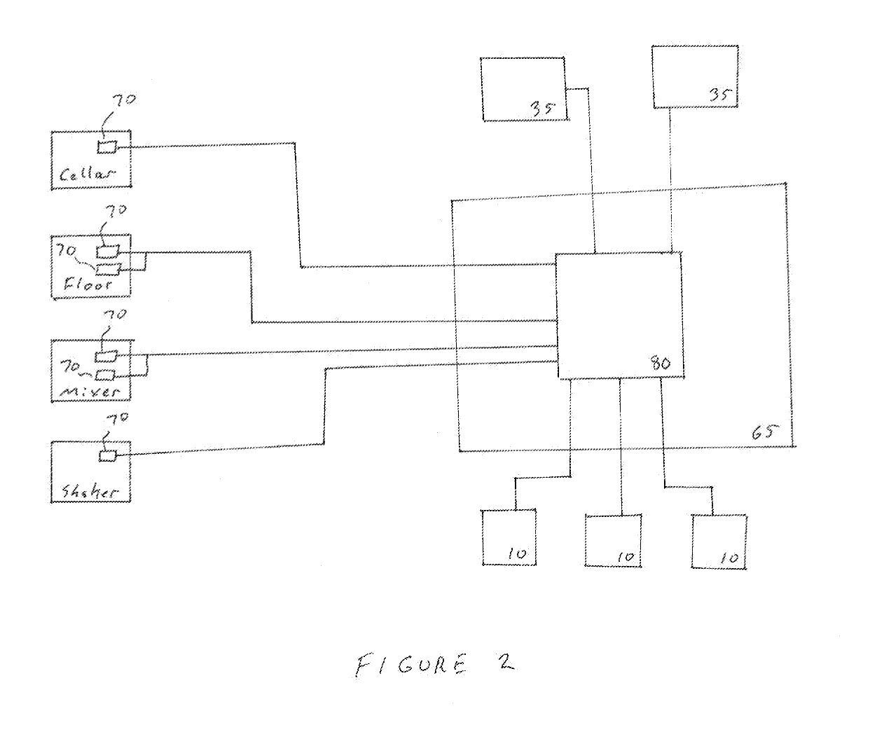

Alarm system 20 includes an alarm condition detection system 60. Alarm condition detection system 60 is a means for detecting a danger, such as a gas detection system. Alarm condition detection system 60 includes a plurality of alarm detectors which are typically positioned at different locations. For example, in the case depicted in FIG. 2, alarms 70 are located at locations such as the cellar, floor, at the mixer, and at the shaker. More than one alarm may be present at each of these locations.

Alarm condition detection system 60, such as a gas detection system, is in communication with control panel 80. Alarm condition detection system 60 may be in wired or wireless communication with control panel 80, but is more typically wired to control panel 80.

Control panel 80 is normally located in a safe location, such as a breathing air trailer 65. Control panel 80 includes converter 90, for example that converts 120 Volt power provided by a standard electrical plug to twelve (12) volts to power control panel 80. Alternatively control panel 80 may be powered by rechargeable batteries. Alarm ports 30 are used to enable the operation of, and communicate instructions to, outdoor audible/visible area alarms 35. Relay boards 40, 45 control wireless control board 50 and alarm ports 30, respectively.

Alarm out port 30 may be a six prong military plug, although other out ports can be used without departing from the invention.

Alarm port 55 is configured to actuate relay boards 40, 45 that provide a signal to activate wireless control board 50 and a plurality of wired alarm ports 30 (which may be 6 prong military prongs), respectively. The plurality of wired alarm ports 30 may include four ports, each 12 volts, although more or less alarm ports may be used of different voltages. The relays 40, wireless control board 50 and associated wiring and peripherals may be housed in a water resistant, dust tight polyvinyl chloride (PVC) enclosure.

The alarm ports 30 in communication with relay board 45 are powered by convertor 90, for example a converter that converts 120 Volt power provided by a standard electrical plug to twelve (12) volts. In an embodiment of the invention, each alarm port 30 may have an output of two (2) amps.

Wireless control board 50 is configured to communicate, for example to provide a wireless signal to a plurality of locations (for example twenty four (24) locations), and to actuate a number of relays (for example eight (8) wireless relays) per location. Board 50 uses wireless protocols, for example, 802.15.4 wireless transmission protocols, and can effectively relay signals from 300 ft. to one mile or more distant (line of site and obstruction dependent). Control board 50 may be merged with the individual relay boards 40 when manufactured to help eliminate the potential for interference. An external antenna may be utilized to increase the signal strength from control board 50 to the relay boards 110.

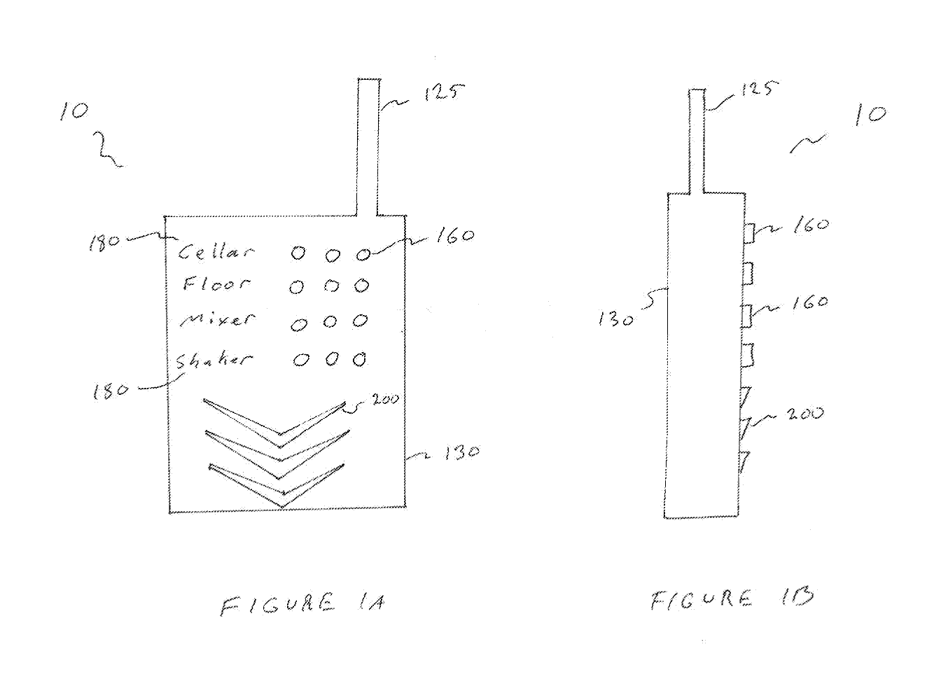

The wireless signals are sent from control panel 80 to personal alarm panel 130 in personal evacuation alarm 10. Personal alarm panel 130 includes wireless relay board 110 and alarm board 120. Wireless relay board 110 may be connected through a 120v to 12v power regulator through a power source such as a wall based power outlet. In such an embodiment, the regulator provides power to both the wireless relay board 110 and alarm board 120. Wireless relay board 110 may use an external antenna 125 for communication. The wireless relay boards 110 and alarm board 120 may be housed in an enclosure 130 as shown in FIG. 1.

In the embodiment described above, the evacuation alarm 10 is typically placed on a desk or other surface in an enclosed environment, such as a trailer at a work site. Such a trailer may contain one or two such evacuation alarms. In an alternative embodiment, evacuation alarm 10 may be powered using a rechargeable battery and may be carried by, for example on the belt of, individuals working on the site.

Alarm board 120 includes a plurality of LED light assemblies 160. For example, in the embodiment shown in FIG. 1A, four sets of alarms, each with three LED light assemblies is used. The LED lights are colour coded in horizontal rows to signify different zones 180 being monitored. For example, in an embodiment of the invention, Zone #1 indicates the Cellar and the corresponding LEDs are red. Zone #2 indicates the Floor and the corresponding LEDs are blue. Zone #3 indicates the Mixer—and the corresponding LEDs are orange, and Zone #4 indicates the Shaker and the corresponding LEDs are white. Such a colour pattern is appropriate for many drilling operations, but other color patterns may be used without departing from the spirit of the invention. In a typical embodiment of the invention all three LEDs in a row will light on an alarm, although in different embodiment if the invention, the number of LEDs lighting may carry significance, such as the particular risk level detected, or the distance of the particular personal evacuation alarm from the area in which the alarm condition was detected, or even coded to particular evacuation sites or means.

The zones 180 may each be wired to independent relays in wireless relay board 110 and powered by a power source, for example a 12v wall plug or rechargeable battery.

In an embodiment of the invention three additional white LEDs 200 are positioned in a column near the base of alarm board 120 to provide illumination to the clear chevron pattern on the front case of enclosure 130. These white LEDs provide the end user with verification that the unit is receiving power. Alarm board 120 also has an audible alarm such as a 97 dB Piezo Buzz alarm. The audible alarm actuates on activation of any of the four alarm zones 180. Personal alarm 10 may include a volume control for the audible alarm.

In an alternative embodiment of personal evacuation alarm 10, rather than, or in addition to LEDs 160, 180, a screen may be provided, the screen displaying a color associated with the zone and also displaying text relating to the location of the gas detection and the mustering location for the evacuation. In such an embodiment personal evacuation alarm 10 may include directions to the mustering point based on the location of the personal evacuation alarm (the location may be predetermined or determined using a GPS receiver in personal alarm 10 or other geographic determination methods).

In another alternative embodiment of the invention, the system 20 may receive and use information about wind information, such as wind speed and direction to evaluate the risk and select or remove from consideration certain mustering points. The wind information may be fed into control panel 50 using sources available on the Internet, and the directions sent to the personal evacuation alarms 10 may be varied depending on the gas detection location and the wind information. Alternatively, each personal evacuation alarm may be wirelessly connected to the Internet and receive wind information, and itself alter the directions to a mustering point based on the location of the gas and the wind information.

In use the system according to the invention acts as follows: first the alarm condition detection system 60, such as a gas detector establishes the presence of gas on the jobsite and relays the information to control board 50. Control board 50 then activates an alarm port 30 and provides a 12v signal to the alarm port 30.

The 12v signal is received through a wire cable that runs from the gas detection system 60 to control board 50. Relays 40, 45 use that signal to determine which channels to enable in both the wired alarm ports 30 and the control board 50.

The wireless control board 50 sends out an 805.15.4 signal to all paired wireless relays boards 110 having the appropriate relay to activate. The personal evacuation alarms 10 goes into alarm mode and an audible alarm will sound as well as lighting the appropriate LED zone 180. Personnel on seeing or hearing the alarms should evacuate to the nearest muster point, or the point as indicated by the evacuation alarm 10.

Once the gas detector that no gas is present and the alarm parameters are not met the system deactivates and all personal evacuation alarms 10 are shut down and return to standby mode.

The system can be utilized in the oil and gas industry during drilling and completions operations. The system can be added to current gas detection systems available to industry to provide a safer workplace for all personnel on site. The system according to the invention can be used wherever gas detection and evacuation notices will assist with the health and safety of the public.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

What is claimed is:

1. A wireless personal evacuation device, comprising:
a wireless receiver for receiving signals related to a presence of gas and a location associated with the gas presence;
a plurality of light emitting diodes arranged in rows, the diodes in each row having a different color;
an audio emitter;
a control board for processing the signal
wherein on receipt of the signal, the control board actuates the diodes in the row corresponding to the location.

2. The wireless personal evacuation device of claim 1, wherein the device is located in a different building from the location.

3. The wireless personal evacuation device of claim 1 further comprising:
an audible alarm actuated on receipt of the signal.

4. The wireless personal evacuation device of claim 1, wherein the diodes further indicate the device is powered.

5. The wireless personal evacuation device of claim 1, wherein the location is associated with one of a plurality of zones.

6. The wireless personal evacuation device of claim 5, wherein the diodes are arranged in rows on the device, each row associated with one of the plurality of zones.

7. The wireless personal evacuation device of claim 6, wherein each row of diodes is a different color.

8. A personal evacuation alarm system, comprising:
a gas detection system;
a control panel in communication with the gas detection system, the control panel comprising:
a wireless control board; and
a plurality of alarm ports, each alarm port connected to an outdoor audio alarm; and
a plurality of personal devices in wireless communication with the control panel, each of the personal devices comprising:
a plurality of light emitting diodes; and
an audio emitter.

9. The personal evacuation alarm system of claim 8, wherein the control panel is configured to receive a signal from the gas detection system indicating a presence of gas and a zone associated with the presence.

10. The personal evacuation alarm system of claim 9, wherein the plurality of light emitting diodes are arranged in rows, each row associated with a zone.

11. The personal evacuation alarm system of claim 10, wherein the control panel is configured to send a wireless signal to each of the plurality of personal devices, the signal including the zone associated with the gas presence.

12. The personal evacuation alarm system of claim 11, wherein each of the personal devices is configured to actuate the row of light emitting diodes associated with the zone indicated in the received signal.

13. The personal evacuation alarm system of claim 12, wherein the personal devices are positioned in buildings different from the gas detection system.

14. The personal evacuation alarm system of claim 13, wherein the control panel is further configured to actuate a plurality of outdoor audio alarms on receipt of the signal indicating the presence of gas.

15. A method of providing a personal evacuation signal, comprising:
determining, by a gas detection system, a presence of gas and a zone associated with a location of the gas;
communicating the presence of gas and the zone via a wired connection to a control panel;
communicating the presence of gas and the zone via a wireless connection to a plurality of personal devices; and
emitting a visible and auditory signal from each of the personal devices.

16. The method of claim 15, wherein the personal devices are located in buildings different from the gas detection system.

17. The method of claim 16, wherein the visible signal comprises the actuation of a plurality of light emitting diodes, the light emitting diodes positioned in a row associated with the zone.
